(19) United States
(12) Patent Application Publication
(10) Pub. No.: US 2019/0041517 A1
(43) Pub. Date: Feb. 7, 2019

(54) OBJECT DETECTION APPARATUS

(71) Applicant: Hoshibumi Ichiyanagi, Aichi (JP)

(72) Inventor: Hoshibumi Ichiyanagi, Aichi (JP)

(73) Assignee: OMRON AUTOMOTIVE ELECTRONICS CO., LTD., Aichi (JP)

(21) Appl. No.: 16/054,556

(22) Filed: Aug. 3, 2018

(30) Foreign Application Priority Data
Aug. 3, 2017 (JP) 2017-150521

(51) Int. Cl. G01S 17/42; G01S 17/93; G01N 21/64

(52) U.S. Cl. CPC G01S 17/42; G01N 21/64; G01S 17/936

(57) ABSTRACT

An object detection apparatus includes: a light emitting unit; a light receiving unit; an object detection unit; a lightness and darkness determination unit that determines an ambient state of lightness or darkness; a signal amplification unit that sets an amplification ratio for a light reception signal and causes the light reception signal to be output from the light receiving unit at a level in accordance with the amplification ratio; and an amplification control unit that controls the amplification ratio for the light reception signal. The amplification control unit causes an amplification ratio for the light reception signal in a case where the lightness and darkness determination unit determines that the ambient state is dark to be higher than an amplification ratio for the light reception signal in a case where the lightness and darkness determination unit determines that the ambient state is light.

### CROSS-REFERENCES TO RELATED APPLICATIONS

This application is based upon and claims the benefit of priority from Japanese Patent Application No. 2017-150521, filed on Aug. 3, 2017; the entire contents of which are incorporated herein by reference.

### FIELD

One or more embodiments of the present invention relate to an object detection apparatus that projects light from a light emitting unit and, based on a result of a light receiving unit receiving reflection light that results from the projected light being reflected, determines whether an object is present or absent or measures a distance to the object.

### BACKGROUND

For example, an object detection apparatus, such as a laser radar, is mounted in a vehicle or the like that has a collision prevention function. Included in the object detection apparatus are a light receiving unit for projecting light, and a light receiving unit for receiving the light. A light emitting element, such as a laser diode, is provided in the light emitting unit. A light receiving element, such as a photodiode or an avalanche photodiode, is provided in the light receiving unit.

Light that is emitted by the light emitting element of the light emitting unit is projected over a prescribed range outside of the object detection apparatus. When the projection light is reflected from the object in the prescribed range, the reflection light is received in the light receiving element of the light receiving unit. Then, based on a light reception signal that is emitted from the light receiving unit according to a light-received state of the light receiving element at that time, it is determined whether an object is present or absent and a distance is measured.

Light that is received by the light receiving element includes not only the reflection light that results from the laser light emitted by the light emitting element being reflected from the object, but also ambient light such as solar light. Furthermore, a signal that is based on the light which is received by the light receiving element and noise other than the signal, which results from characteristics of the light receiving element or the light receiving unit are included in the light reception signal that is output from the light receiving unit.

As an amount of ambient light that is incident on the light receiving element increases, a level of the noise that is included in the light reception signal from the light receiving unit is raised. Then, it is difficult to distinguish between the reflection light signal and the noise, which are included in the light reception signal, and the precision of the detection of the object deteriorates. For this reason, a technology that suppresses an influence of the ambient light is proposed in various ways.

For example, in JP-A-2004-325202, it is disclosed that light that is emitted by the light emitting unit is scanned by a scanning drive unit, that an area for detecting the object is formed, and that a detection unit determines whether a light source is present or absent, based on the light reception signal that is output from the light receiving unit. Then, when the detection determines that the light source which is formed by the ambient light within the area is present, a scanning range of the light from the light emitting unit is adjusted by the scanning drive unit in such a manner that the light source is out of the area.

In JP-A-2005-180994, it is disclosed that a position of the Sun, a position of a vehicle, and positioning of the vehicle are measured based on information such as a calendar and time that are acquired from a navigation device that is mounted in the vehicle, and that illuminance is measured based on a result of detection by an illuminance sensor. Then, based on these results of the detection, it is determined whether or not a straight line that connects between the object detection apparatus and the Sun is in a range of an incident angle at which light is incident on the light receiving unit, and according to a result of the determination, a threshold for determining a sunlight obstacle with a comparison with the light reception signal and the time that elapses for the determination.

In JP-A-2014-077658, it is disclosed that light receiving surfaces of a plurality of light receiving units are arranged in an array and that an output of the photodiode that is provided in each light receiving unit is added by an addition unit. Then, turning-on or -off of each light receiving unit is controlled in such a manner that a value that is added by the addition unit is maximized and that the number of light receiving units that are in a turned-on state is as small as possible. Thus, only the light receiving unit on which the reflection light is incident is in the turned-on state.

In JP-A-H07-035858, it is disclosed that a threshold increases gradually, that it is repeatedly measured whether or not a level of ambient light that is included in the light reception signal which is output from the light receiving unit, and thus that a threshold at a low level is set in a range where an influence of the ambient light is not exerted. Then, the reflection light at or above the threshold is introduced into a light receiving circuit.

In JP-A-H08-075455, it is disclosed that in a CCD camera, a convex lens is positioned in front to a CCD and a liquid crystal plate is positioned in front of the convex lens, and that lightness of a photographic subject is measured by the CCD. Then, in the daytime or the like during which a value of lightness, which is measured by the CCD, is at or above a minimum required value, a voltage that is applied to the liquid crystal plate is switched off and a transmittance of the liquid crystal plate is decreased, and thus an amount of light incident on the convex lens is decreased. Furthermore, in the nighttime or the like during which the value of lightness, which is measured by the CCD, is below the minimum required value, the voltage that is applied to the liquid crystal plate is increased (switched on) and the transmittance of the liquid crystal plate is increased, and thus the amount of light incident on the convex lens is increased.

### SUMMARY

Raising the level of the light reception signal is effective at making it easy to detect the reflection light signal that results from the object. However, when this is done, the level of the noise that is included in the light reception signal is also raised. When an ambient state is light such as in the daytime, an amount of ambient light, such as solar light, that is incident on the light receiving unit, is large. Because of this, the level of the noise that is included in the light reception signal which is output from the light reception unit is raised. For this reason, when the light reception signal is too much amplified, the level of the noise is further raised and it is difficult to distinguish between the reflection light signal and the noise. Thus, there is a concern that the precision of the determination of whether the object is present or absent and of the measurement of the distance to the object will be decreased.

In contrast, when an ambient state is dark such as in the nighttime, the amount of ambient light, such as solar light, that is incident on the light receiving unit, is small. Because of this, the level of the noise that is included in the light reception signal which is output from the light reception unit is lowered. For this reason, when the light reception signal that results when the ambient state is dark is amplified with the amplification ratio that is set to be low considering the ambient state is light, there is a concern that the level for the reflection light signal will be raised effectively and that the object will not be detected with precision. Furthermore, because in the ambient state is dark, it is difficult for a driver of a vehicle or the like to visually recognize an object with the naked eye, it is desirable that the precision of the detection of the object by an object detection apparatus is improved.

An object of one or more embodiments of the present invention is to provide an object detection apparatus that is capable of improving the precision of detection of an object not only when an ambient state is light, but also when an ambient state is dark.

According to an aspect of the present invention, there is provided an object detection apparatus including: a light emitting unit including a light emitting element that projects light over a prescribed range; a light receiving unit including a light receiving element that receives reflection light resulting from an object existing in the prescribed range over which the light is projected from the light emitting element; an object detection unit that detects the object based on a light reception signal output from the light receiving unit according to a light-received state of the light receiving element; a lightness and darkness determination unit that determines an ambient state of lightness or darkness; a signal amplification unit that sets an amplification ratio for the light reception signal and causes the light reception signal to be output from the light receiving unit at a level in accordance with the amplification ratio; and an amplification control unit that controls the amplification ratio for the light reception signal. The amplification control unit causes an amplification ratio for the light reception signal in a case where the lightness and darkness determination unit determines that the ambient state is dark to be higher than an amplification ratio for the light reception signal in a case where the lightness and darkness determination unit determines that the ambient state is light.

When implementation is realized as described above, the light reception signal that is output from the light receiving unit is amplified by the signal amplification unit, not only when the ambient state is light, but also when the ambient state is dark. Because of this, a level for a reflection light signal that results from the object, which is included in the light reception signal, is raised, and the object can be easily detected based on the reflection light signal. Furthermore, the amplification ratio for the light reception signal, which results when an amount of ambient light that is incident on the light receiving unit is small and the ambient state is dark is set to be higher than the amplification ratio for the light reception signal, which results when the amount of ambient light that is incident on the light receiving unit is large and the ambient state is light. For this reason, when the ambient state is dark, the reflection light reception signal that is included in the light reception signal is set to be higher, and thus the reflection light signal can be easily distinguished from the noise that is included in the light reception signal, and the precision of the detection of the object, which is based on the reflection light signal, can be improved. Furthermore, when the ambient state is light, the amplification ratio for the light reception signal is suppressed to be lower than when the ambient state is dark. Because of this, without excessively raising the level for noise that is included in the light reception signal, the noise and the reflection light signal can be easily distinguished and the precision of the detection of the object that is based on the reflection light signal can be improved.

In the aspect of the present invention, the light receiving element may include an avalanche photodiode, the signal amplification unit may include a reverse voltage generation unit that generates a reverse voltage and applies the generated reverse voltage to the avalanche photodiode, and the amplification control unit may cause the reverse voltage generation unit to change the amplification for the light reception signal by changing the reverse voltage to be applied the avalanche photodiode.

Furthermore, in the aspect of the present invention, the lightness and darkness determination unit may determine the ambient state of lightness or darkness based on calendar information, positional information, a result of detection by a solar radiation sensor, or a state where an illumination device that illustrates a vicinity thereof is turned on or off, which are acquired from an outside, or determination data including the light reception signal.

Furthermore, in the aspect of the present invention, the lightness and darkness determination unit may estimate a level for ambient light based on the determination data, and the amplification control unit may change the amplification ratio for the light reception signal based on the level for the ambient light.

Moreover, in the aspect of the present invention, the amplification control unit may estimate a level of shot noise based on the level of the ambient light estimated by the lightness and darkness determination unit, and may change the amplification ratio for the light reception signal based on the level of the shot noise and a level of circuit noise that is stored in advance.

According to one or more embodiments of the present invention, it is possible to provide an object detection apparatus that is capable of improving the precision of detection of an object when an ambient state is light, but also when an ambient state is dark.

### BRIEF DESCRIPTION OF DRAWINGS

FIG. 1 is a diagram illustrating a state of an optical system of an object detection apparatus according to an embodiment of the present invention, which viewed from above;

FIG. 2 is a diagram illustrating a state of the optical system of the object detection apparatus in FIG. 1, when viewed from the rear;

FIG. 3 is a diagram illustrating an electrical configuration of the object detection apparatus in FIG. 1;

FIG. 4 is a diagram illustrating a relationship between a reverse voltage of and an amplification ratio for an APD;

FIG. 5 is a diagram illustrating a relationship between the amplification ratio for and an output of the APD;

FIG. 6 is a flowchart illustrating operation of the object detection apparatus in FIG. 1;

FIG. 7 is a diagram illustrating a table for a time, a place, and ambient light;

FIG. 8 is a diagram illustrating a table for an amount of solar radiation and ambient light;

FIG. 9 is a diagram illustrating a table for a headlamp and diagram;

FIG. 10 is a diagram illustrating a table for ambient light and noise;

FIG. 11 is a diagram illustrating a light reception signal that is output from a light receiving module in FIG. 3 when an ambient state is light;

FIG. 12 is a diagram illustrating the light reception signal that is output from the light receiving module in FIG. 3 when an ambient state is dark;

FIG. 13 is a diagram illustrating an electrical configuration of an object detection apparatus according to another embodiment of the present invention; and

FIG. 14 is a diagram illustrating an electrical configuration of an object detection apparatus according to another embodiment of the present invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Embodiments of the present invention will be described below with reference to the drawings. The same or corresponding constituent components in figures are the same reference numbers.

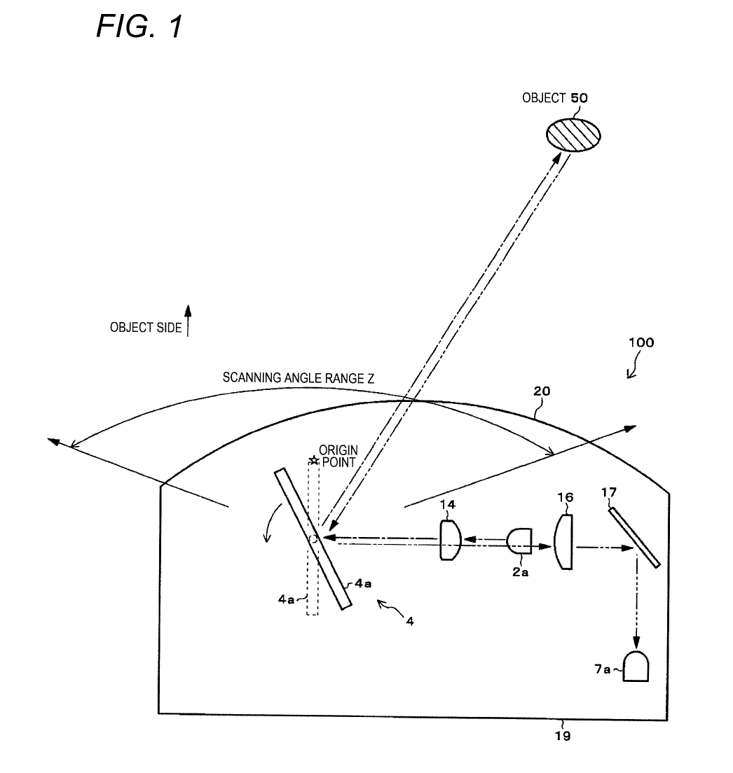

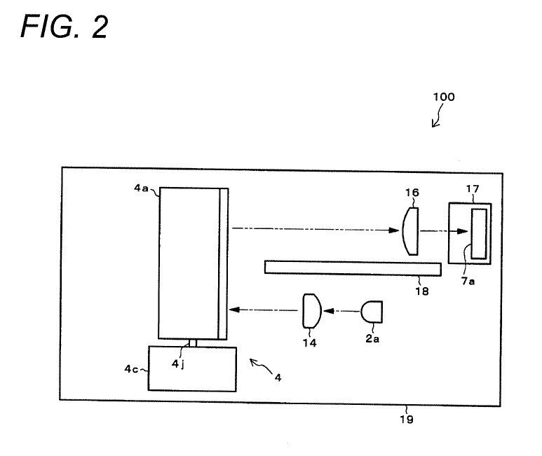

FIG. 1 is a diagram illustrating a state of an optical system of an object detection apparatus 100 according an embodiment, when viewed from above. FIG. 2 is a diagram illustrating a state of the optical system of the object detection apparatus 100, when viewed from the rear (the downward direction in FIG. 1, that is, the direction opposite to an object 50).

The object detection apparatus 100, for example, is formed by a laser radar that is mounted in a four-wheeled vehicle. The optical system of the object detection apparatus 100 is formed by a laser diode (LD) 2a, a light projection lens 14, a rotary scanning unit 4, a light receiving lens 16, a reflecting mirror 17, and an avalanche photodiode (APD) 7a.

The LD 2a, the light projection lens 14, and the rotary scanning unit 4 among these are a light-projecting optical system. Furthermore, the rotary scanning unit 4, the light receiving lens 16, the reflecting mirror 17, and the APD 7a are a light-receiving optical system.

These optical systems are accommodated within a case 19 of the object detection apparatus 100. A front surface of the case 19 (the object 50 side) is opened. The light transmitting window 20 is provided on the front surface of the case 19. The light transmitting window 20 is formed by a window frame that is rectangle-shaped, and a plate that has transmissibility, which is fitted into the window frame (detailed illustrations of these are omitted).

The light transmitting window 20 is installed in such a manner as to face in the forward direction, the backward direction, or the leftward and rightward directions from a vehicle, and the object detection apparatus 100 is installed in the front portion, the rear portion, or the left-side and light-side portions of the vehicle. The object 50 is a preceding vehicle, a person, or other object, that is present outside of the object detection apparatus 100.

The LD 2a is a light emitting element that projects high-output laser light (an optical pulse). In FIGS. 1 and 2, for convenience, only one LD 2a is illustrated, but in practice, a plurality of LDs 2a are arranged in the upward-downward direction in FIG. 2. A light emission surface of the LD 2a is positioned in such a manner as to face toward the rotary scanning unit 4.

The APD 7a is a light receiving element that receives the laser light (projection light) which is projected from the LD 2a, or reflection light or the like which results from the laser light being reflected from the object 50. In FIGS. 1 and 2, for convenience, only one APD 7a is illustrated, but in practice, a plurality of APDs 7a are arranged in an array in the upward-downward direction or the leftward-rightward direction in FIG. 2. A light receiving surface of the APD 7a is positioned in such a manner as to face toward the reflecting mirror 17.

The rotary scanning unit 4 is also referred to as a rotating mirror or an optical deflector. The rotary scanning unit 4 includes a mirror 4a, a motor 4c, and the like. The mirror 4a is formed in the shape of a plate. A front surface and a rear surface of the mirror 4a are reflective surfaces.

As illustrated in FIG. 2, the motor 4c is provided under the mirror 4a. A rotation shaft 4j of the motor 4c is in parallel to the upward-downward direction. A connection shaft (not illustrated) that is present at the center of the mirror 4a is fixed to the upper end of the rotation shaft 4j of the motor 4c. For rotation, the mirror 4a interlocks with the rotation shaft 4j of the motor 4c.

Within the case 19, the light receiving lens 16, the reflecting mirror 17, and the APD 7a are arranged in the vicinity of an upper portion of the mirror 4a of the rotary scanning unit 4. The LD 2a and the light projection lens 14 are arranged in the vicinity of a lower portion of the mirror 4a. A light shielding plate 18 is provided over the LD 2a and the light projection lens 14 and under the light receiving lens 16. The light shielding plate 18 is fixed within the case 19, and separates a light projection path and a light reception path.

The light projection and light reception paths for detecting the object 50 are as indicated by one-dot chain line and two-dot chain line arrows, respectively, in FIGS. 1 and 2. Specifically, as illustrated by the one-dot chain line arrow in FIGS. 1 and 2, spread of the laser light that is projected from the LD 2a is adjusted by the light projection lens 14, and then reaches a half portion of a front surface or a rear surface of the mirror 4a of the rotary scanning unit 4. On this occasion, the motor 4c rotates, and thus an angle (a slope) of the mirror 4a changes and the front surface or the rear surface of the mirror 4a is inclined at a prescribed angle to face toward the object 50 (for example, a state of the mirror 4a that is indicated by a solid line in FIG. 1). Accordingly, the laser light from the LD 2a passes through the light projection lens 14, and then is reflected from a half portion of the front surface or the rear surface of the mirror 4a, passes through the light transmitting window 20 and is scanned over a prescribed range outside of the case 19. More precisely, the rotary scanning unit 4 deflects the laser light from the LD 2a over the prescribed range.

A scanning angle range Z that is illustrated in FIG. 1 is a range (when viewed from above) where the laser light from the LD 2a is reflected from the front surface or the rear surface of the mirror 4a of the rotary scanning unit 4 and is projected from the object detection apparatus 100. That is, the scanning angle range Z is a range where the object 50 is detected by the object detection apparatus 100.

As described above, the laser light that is projected over the prescribed arrange from the object detection apparatus 100 is reflected from the object 50 that is present in the prescribed range. The reflection light, as indicated by the two-dot chain line arrow in FIGS. 1 and 2, passes through the light transmitting window 20, and reaches a half portion of the front surface or the rear surface of the mirror 4a. On this occasion, the motor 4c rotates, and thus the angle (the slope) of the mirror 4a changes and the front surface or the rear surface of the mirror 4a is inclined at a prescribed angle to face toward the object 50 (for example, a state of the mirror 4a that is indicated by a solid line in FIG. 1). Accordingly, the reflection light from the object 50 is reflected from a half portion of the front surface or the rear surface of the mirror 4a, and is incident on the light receiving lens 16. More precisely, the rotary scanning unit 4 deflects the reflection light from the object 50 toward the light receiving lens 16. Then, the reflection light is focused in the light receiving lens 16, and then is reflected from the reflecting mirror 17 and is received in the APD 7a. More precisely, the rotary scanning unit 4 guides the reflection light from the object 50 to the APD 7a via the light receiving lens 16 and the reflecting mirror 17.

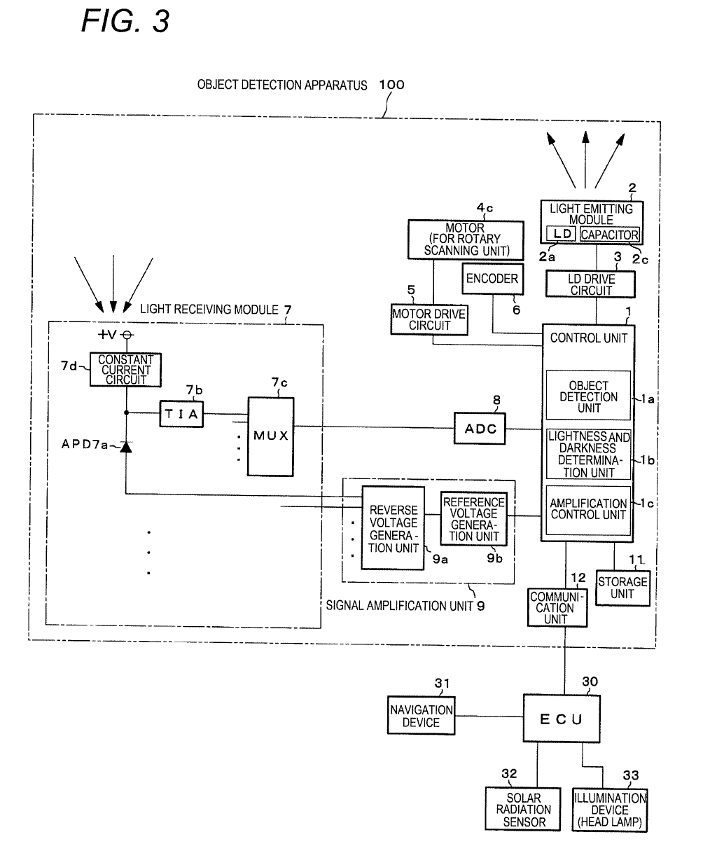

FIG. 3 is a diagram of an electrical configuration of the object detection apparatus 100. The object detection apparatus 100 includes a control unit 1, a light emitting module 2, an LD drive circuit 3, the motor 4c, a motor drive circuit 5, an encoder 6, a light receiving module 7, an analog-to-digital converter (ADC) 8, a signal amplification unit 9, a storage unit 11, and a communication unit 12.

The control unit 1 is formed by a microcomputer or the like, and controls operation of each of the units of the object detection apparatus 100. Provided to the control unit 1 are an object detection unit la, a lightness and darkness determination unit 1b, and an amplification control unit 1c.

The storage unit 11 is formed by a volatile or nonvolatile memory. Stored in the storage unit 11 are information that is necessary for the control unit 1 to control each of the units of the object detection apparatus 100, information for detecting the object 50, information relating to ambient light or noise, or the like.

The communication unit 12 is formed by a circuit for communicating with an electronic control unit (ECU) 30 that is mounted in the vehicle. The ECU 30 is connected to a navigation device 31, a solar radiation sensor 32, and an illumination device 33.

For example, with the communication unit 12, the control unit 1 transmits a result of the detection of the object 50 to the ECU 30. Furthermore, with the communication unit 12, the control unit 1 communicates with the ECU 30, and thus acquires necessary information from the navigation device 31, the solar radiation sensor 32, or the illumination device 33. Specifically, the control unit 1 acquires a current calendar information or a positional information on the vehicle from the navigation device 31. Furthermore, the control unit 1 acquires a result of measurement of an amount of ambient solar radiation by the solar radiation sensor 32. Furthermore, the control unit 1 acquires a state where the illumination device 33 (a headlamp or the like) that illuminates the vicinity of the vehicle that is turned on or off.

The plurality of LDs 2a described above, a capacitor 2c for causing each of the LDs 2a to emit light, and the like are provided in the light emitting module 2. In FIG. 3, for convenience, one block of the LDs 2a and one block of the capacitors 2c are illustrated. The light emitting module 2 is an example of a “light emitting unit” according to one or more embodiments of the present invention.

The control unit 1 controls operation of the LD 2a of the light emitting module 2 using the LD drive circuit 3. Specifically, the control unit 1 causes the LD 2a to be emitted using the LD drive circuit 3, and thus projects the laser light. Furthermore, the control unit 1 causes the LD 2a to stop emitting light using the LD drive circuit 3 and charges the capacitor 2c.

The motor 4c is a drive source that causes the mirror 4a of the rotary scanning unit 4 to be driven. The control unit 1 controls the driving of the motor 4c using the motor drive circuit 5 and causes the mirror 4a to rotate. Then, the control unit 1, as described above, causes the mirror 4a to rotate, and thus, causes the laser light, which is projected from the LD 2a, to be scanned over the prescribed range and leads the reflection light, which is reflected from the object 50 that is present in the prescribed range, to the APD 7a. On this occasion, based on an output of the encoder 6, the control unit 1 detects a rotation state (a rotation angle or the number of rotations) of the motor 4c or the mirror 4a.

Included in the light receiving module 7 are the APD 7a, a trans-impedance amplifier (TIA) 7b, a multiplexer (MUX) 7c, and a constant current circuit 7d. The light receiving module 7 is an example of a “light receiving unit” according to one or more embodiments of the present invention.

A plurality of APDs 7a, a plurality of TIAs 7b, and a plurality of constant current circuits 7d are provided in such a manner as to be grouped into sets of one APD 7a, one TIA 7b, and one constant current circuit 7d. In FIG. 3, typically, one set of the APD 7a, the TIA 7b, and the constant current circuit 7d is illustrated, but two or more of the APD 7a, the TIA 7b, and the constant current circuit 7d are also provided in the same manner. A light receiving channel is configured without each set of the APD 7a and the TIA 7b. More precisely, a plurality of light receiving modules 7 are provided in the light receiving channel.

A cathode of the APD 7a is connected to a power source +V via the constant current circuit 7d. An input terminal of the TIA 7b is connected between the cathode of the APD 7a and the constant current circuit 7d. An output terminal of the TIA 7b is connected to the MUX 7c. An anode of the APD 7a is connected to a reverse voltage generation unit 9a of the signal amplification unit 9.

The APD 7a outputs current by receiving light. The TIA 7b converts current flowing through the APD 7a to a voltage signal and outputs the voltage signal to the MUX 7c. In order to suppress power consumption by the APD 7a, the constant current circuit 7d limits current flowing through the APD 7a.

The signal amplification unit 9 includes the reverse voltage generation unit 9a and a reference voltage generation unit 9b. The reverse voltage generation unit 9a is formed by a DC-DC converter. The reference voltage generation unit 9b is formed by a pulse width modulation (PWM) circuit that generates a reference voltage which is input into the reverse voltage generation unit 9a. With the PWM, the reference voltage generation unit 9b generates the reference voltage and inputs the generated reference voltage into the reverse voltage generation unit 9a. Then, the reverse voltage generation unit 9a generates a reverse voltage (a reverse bias voltage) based on the reference voltage, and applies the generated reverse voltage to the APD 7a. Accordingly, when receiving light, current that is output from the APD 7a is amplified.

A MUX 7c selects an output signal of each TIA 7b, and outputs the selected output signal to the ADC 8. The ADC 8 converts an analog signal that is output from the MUX 7c, into a digital signal at a high speed, and then, outputs the digital signal to the control unit 1. More precisely, a light reception signal (the voltage signal) in accordance with a light-received state of each APD 7a is output from the light receiving module 7 to the control unit 1 via the ADC 8.

For a duration for which the laser light from the LD 2a is scanned by the rotary scanning unit 4 over the prescribed range, based on the light reception signal that is input from the light receiving module 7 via the ADC 8, the object detection unit 1 a of the control unit 1 determines whether the object 50 is present or absent and measures a distance to the object 50.

Specifically, for example, the object detection unit la compares the light reception signal that is output from the light receiving module 7 via the ADC 8, with a prescribed threshold. Then, if the light reception signal is at or above the threshold, it is determined that the object 50 is present, and if the light reception signal is below the threshold, it is determined that the object 50 is absent. Furthermore, for example, the object detection unit la measures a maximum value of the light reception signal that is at or above the threshold, and based on the maximum value, measures the time when the reflection signal is received by the object 50. Then, based on the reception time for the reflection light and the time when the laser light is projected from the LD 2a, a distance to the object 50 is calculated (a so-called time-of-flight (TOF) method).

Based on determination data that is acquired from the outside or the inside, the lightness and darkness determination unit 1b determines an ambient state of lightness or darkness, and estimates a level of ambient light such as ambient solar light. Pieces of determination data is formed by the calendar information that, with the communication unit 12, is acquired from the navigation device 31 via the ECU 30, the positional information, the result of measurement by the solar radiation sensor 32, the state where the illumination device 33, and the light reception signal from the light receiving module 7.

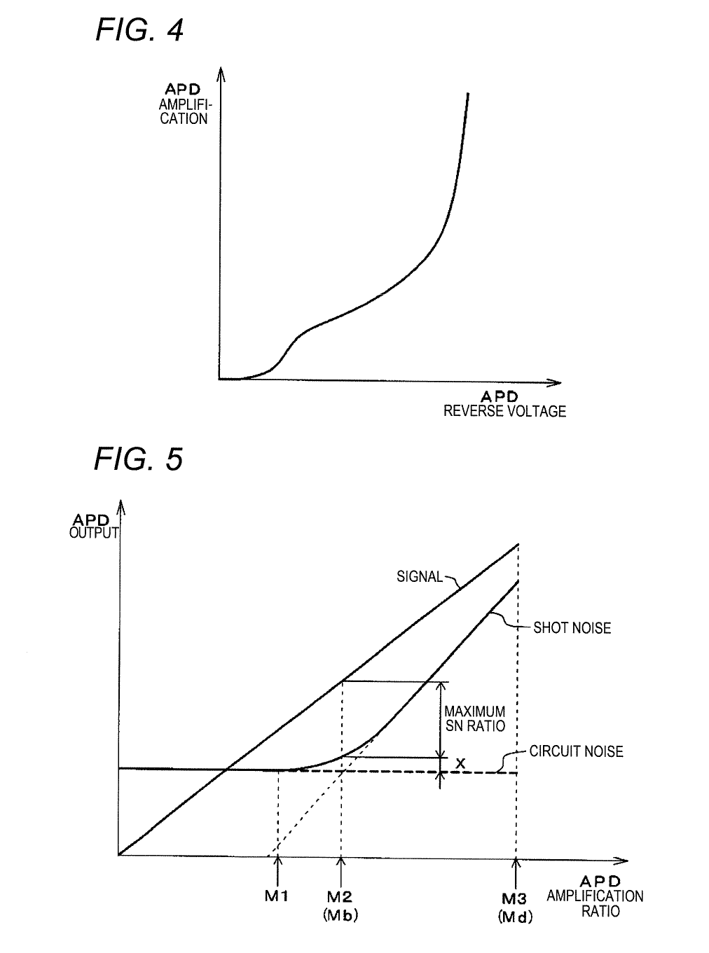

The amplification control unit 1c controls the signal amplification unit 9, and thus changes an amplification ratio for the APD 7a, thereby controlling a level of the light reception signal that is output from the light receiving module 7. This specific method will be described with reference to FIGS. 4 and 5.

FIG. 4 is a diagram illustrating a relationship between the reverse voltage of and the amplification ratio for the APD 7a. FIG. 5 is a diagram illustrating a relationship between the amplification ratio for and an output of the APD 7a.

As illustrated in FIG. 4, as the reverse voltage that is applied to the APD 7a increases, the amplification ratio for the APD 7a increases. Then, when the reverse voltage that is applied to the APD 7a is at or above value, current flows abruptly through the APD 7a and the APD 7a is in a breakdown state.

As illustrated in FIG. 5, as the amplification ratio for the APD 7a increases, the output signal (current) in accordance with the light-received state of the APD 7a increases. A change in the output signal with respect to the amplification ratio for the APD 7a is expressed with a linear function. For this reason, according to an increase in the amplification ratio for the APD 7a, the output signal (a voltage) of the TIA 7b that converts output current of the APD 7a into the voltage signal in the same manner and the light reception signal from the light receiving module 7 is amplified.

The amplification control unit 1c in FIG. 3 controls the reference voltage generation unit 9b of the signal amplification unit 9, and thus changes the reference voltage that is input from the reference voltage generation unit 9b into the reverse voltage generation unit 9a, by performing the PWM. When this is done, the reverse voltage that is provided from the reverse voltage generation unit 9a to the APD 7a is changed, and thus the amplification ratio for the APD 7a changes. As a result, an output level of the APD 7a changes, and thus the amplification ratio for the light reception signal that is output from the light receiving module 7 changes as well. That is, the signal amplification unit 9 sets the amplification ratio for the light reception signal, and causes the light reception signal at a level in accordance with the amplification ratio to be output from the light receiving module 7.

For example, as the amplification control unit 1c increases the reference voltage that is input from the reference voltage generation unit 9b to the reverse voltage generation unit 9a, the reverse voltage that is provided from the reverse voltage generation unit 9a to the APD 7a increases, the amplification ratio for the APD 7a increases as well. Then, as the amplification ratio for the APD 7a, an output of the APD 7a increases, and the level of the light reception signal that is output from the light receiving module 7 is raised. In this manner, the amplification control unit 1c controls the amplification ratio for the light reception signal.

Light that is received by the APD 7a includes not only the reflection light that results from the laser light emitted by the LD 2a being reflected from the object 50, but also the ambient light such as solar light. Furthermore, a signal that is based on the light which is received by the APD 7a, and noise other than the signal are included in the light reception signal that is output from the light receiving module 7. The noise that is included in the light reception signal occurs due to shot noise and the circuit noise of the APD 7a.

The circuit noise depends on ambient temperature and thus is also referred to as thermal noise. As illustrated in FIG. 5, under a certain temperature environment, the circuit noise is constant regardless of the amplification ratio for the APD 7a. As the ambient temperature decreases, the circuit noise decreases.

The shot noise of the APD 7a depends on incident ambient light, and thus, occurs in proportion to a square root (√) of the output signal (the current) of the APD 7a and increases as an amount of the incident ambient light increases. When the amplification ratio for the APD 7a is below a certain value M1, the shot noise is the same as the circuit noise.

When the amplification ratio for the APD 7a is at or above the certain value M1, the shot noise. On this occasion, the shot noise lowers the output signal of the APD 7a, but a change (a slope of the shot noise in FIG. 5) in the shot noise occurs abruptly due to a change (a slope of a signal in FIG. 5) in the output signal of the APD 7a. For this reason, when the amplification ratio for the APD 7a is at a value M2 that is somewhat greater than the M1 (M1<M2), a signal-to-noise (SN) ratio is brought to the maximum, and as the amplification ratio for the APD 7a is lower or higher than the M2, the SN ration deteriorates. In this manner, the SN ratio for the light reception signal from the light receiving module 7 also changes according to the amplification ratio for the APD 7a.

The amplification control unit 1c changes the amplification ratio for the APD 7a in such a manner that the SN ratio for the APD 7a does not deteriorate or in such a manner that the SN ratio is improved, and thus controls the amplification ratio for the light reception signal that is output from the light receiving module 7. As illustrated in FIGS. 4 and 5, information indicating characteristics of the APD 7a is stored in advance in the storage unit 11.

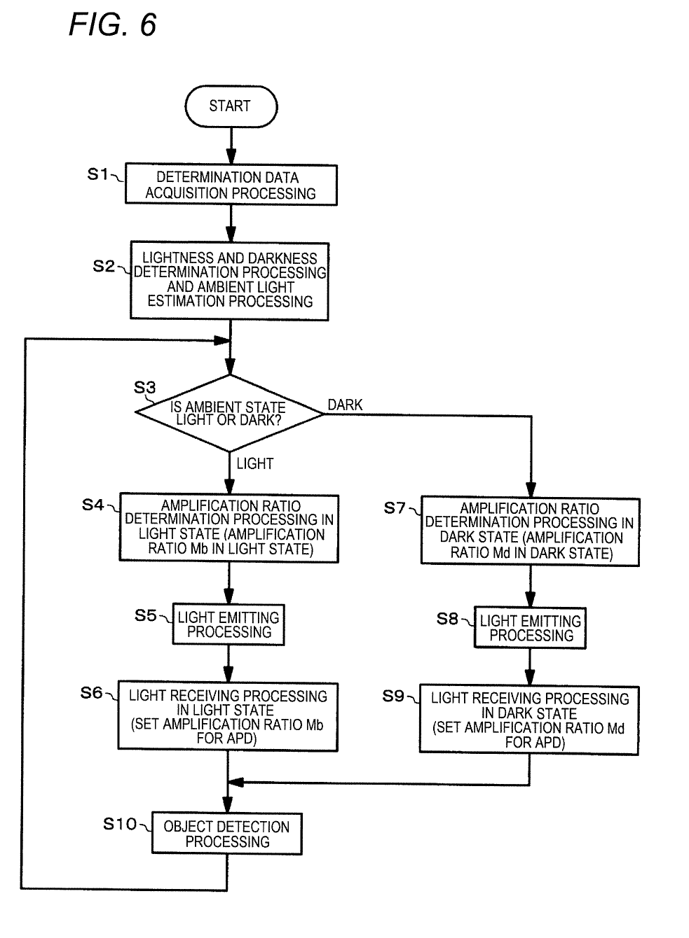

FIG. 6 is a flowchart illustrating operation of the object detection apparatus 100. First, the lightness and darkness determination unit 1b of the control unit 1 performs acquisition processing of the determination data (Step S1). In the acquisition processing, the lightness and darkness determination unit 1b acquires the determination data for determining the ambient state of lightness or darkness. Specifically, for example, calendar information or positional information is acquired from the navigation device 31 via the communication unit 12 and the ECU 30. Furthermore, information indicating an amount of ambient solar radiation that is detected by the solar radiation sensor 32 is acquired. Furthermore, information indicating a state where a headlamp of a vehicle, which is included in the illumination device 33, is turned on or off is acquired. Furthermore, only ambient light is received by the APD 7a without the LD 2a being caused to emit light, and the light reception signal from the light receiving module 7 at this time is acquired via the ADC 8.

Next, the lightness and darkness determination unit 1b performs lightness and darkness determination processing and ambient light estimation processing (Step S2). In the lightness and darkness determination processing, based on the determination data that is acquired in Step S1, the lightness and darkness determination unit 1b determines the ambient state of lightness or darkness. In the ambient light estimation processing, based on the determination data, the lightness and darkness determination unit 1b estimates a maximum level of the ambient light. These two types of processing may be performed individually and may be performed in the same time.

Specifically, for example, based on current date and time that is included in the calendar information which is acquired from the navigation device 31 or on sunrise time and sunset time of the day, the lightness and darkness determination unit 1b determines whether or not a current time is in the daytime or in the nighttime. At this time, if a current time is in the nighttime, the lightness and darkness determination unit 1 b determines that an ambient state is dark. Furthermore, if a current time is in the daytime, from the positional information that is acquired from the navigation device 31, the lightness and darkness determination unit 1b determines whether or not a current position is located at a dark place, such as within a tunnel or inside of the vehicle. Then, if a current position is at a dark place, it is determined that it is dark in the vicinity, and if a current position is not at a dark place, it is determined that the ambient state is light.

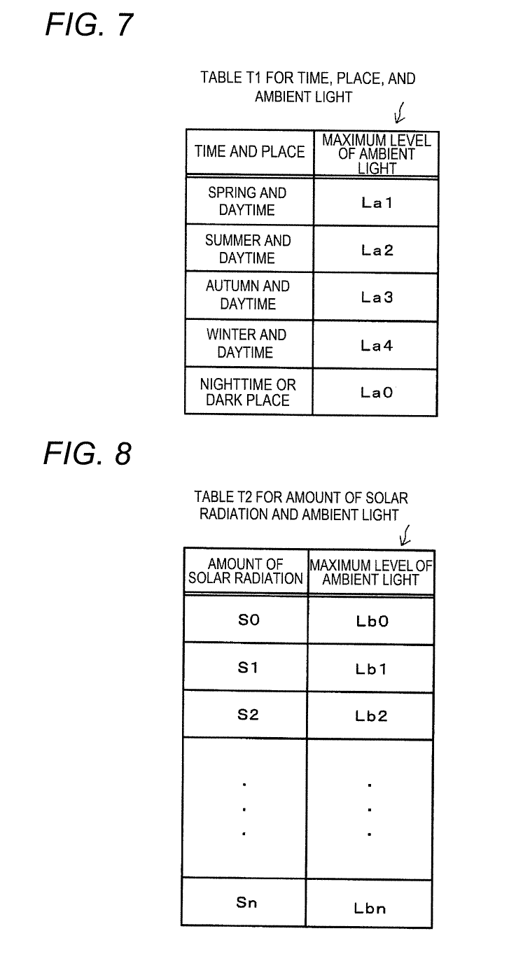

Moreover, based on the above-described result of the determination of whether it is light or dark, a current season that is included in the calendar information, and a table T1 for time, place, and ambient light, as illustrated in FIG. 7, the lightness and darkness determination unit 1b estimates the maximum level of the ambient light. The table T1 for time, place, and ambient light shows maximum levels (maximum amounts of light or the like) La1 to La4 of ambient light (solar light) in the daytime in spring, summer, autumn, and winter, which are measured in advance by a measuring apparatus, and a maximum level La0 of ambient light in the nighttime in each search or at a dark place. Because solar light is not present in the nighttime or at a dark place, the maximum level La0 of ambient light is at a value of 0 (zero) or at a value that is close to 0. Pieces of information in the table T1 for time, place, and ambient light are stored in the storage unit 11. For example, if a current time is in the daytime, the lightness and darkness determination unit 1b estimates that the maximum level of ambient light is at a value La1. Furthermore, if a current time is in the nighttime, or if a current position is at a dark place, it is estimated that the maximum level of ambient light is at a value La0.

Furthermore, based on the amount of solar radiation that is measured by the solar radiation sensor 32, the lightness and darkness determination unit 1b determines whether the ambient state is light or dark. For details, for example, if the amount of solar radiation that is measured by the solar radiation sensor 32 is at or above a prescribed value, it is determined that the ambient state is dark, and if the amount of solar radiation that is measured by the solar radiation sensor 32 is below the prescribed value, it is determined that the ambient state is dark.

Moreover, based on the amount of solar radiation that is measured by the solar radiation sensor 32 and on a table T2 for an amount of solar radiation and ambient light as illustrated in FIG. 8, the lightness and darkness determination unit 1b estimates the maximum level of ambient light. The table T2 for an amount of solar radiation and ambient light shows amounts S0, S1, S2, . . . Sn of solar radiation, which are measured in advance by the solar radiation sensor 32, on different date and times or at different places, and maximum levels Lb0, Lb1, Lb2, Lbn of ambient light, which are measured by the measuring apparatus at respective time, in such a manner that the amounts are stepwise (in increasing order) associated with the maximum levels, respectively. Because the amount S0 of solar radiation is at a value of 0 or at a value that is close to 0, the maximum level Lb0 that is associated with the amount S0 of solar radiation is also at a value of 0 or at a value of that is close to 0. Pieces of information in the table T2 for an amount of solar radiation and ambient light are stored in the storage unit 11. For example, if the amount of solar radiation that is measured by the solar radiation sensor 32 is at a value S0 or below a value S1, the lightness and darkness determination unit 1b estimates that the maximum level of ambient light is at a value Lb0. Furthermore, if the amount of solar radiation that is measured by the solar radiation sensor 32 is at or above a value S1 and below a value S2, it is estimated that the maximum level of ambient light is at a value Lb1.

Furthermore, based on the state where the headlamp is turned on or off, the lightness and darkness determination unit 1b determines whether or not the ambient state is light or dark. For details, for example, if the headlamp is in a turned-on state, it is determined that the ambient state is dark and if the headlamp is in a turned-off state, it is determined that the ambient state is light.

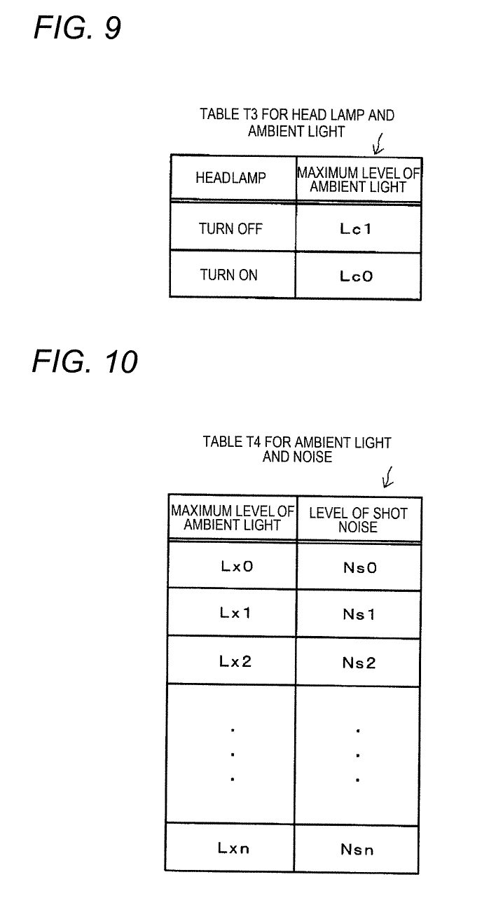

Moreover, based on the state where the headlamp is turned on or off and on a table T3 for a headlamp and ambient light, which is illustrated in FIG. 9, the lightness and darkness determination unit 1b estimates the maximum level of ambient light. In the table T3 for a headlamp and ambient light, a maximum level Lc1 of ambient light (solar light) in the daytime, which is measured in advance by the measuring apparatus is associated with the state where the headlamp is turned on or off. A maximum level Lc0 of ambient light is associated with the state where the headlamp is turned on or off. When the headlamp is turned on, because the ambient state is dark, such as the nighttime, the maximum level Lc0 of ambient light is at a value of 0 or at a value that is close to 0. Pieces of information in the table T3 for a headlamp and ambient light are stored in the storage unit 11. If the headlamp is in the turned-off state, the lightness and darkness determination unit 1b estimates that the maximum level of ambient light is at a value Lc1, and, if the headlamp is in the turned-on state, estimates that the maximum level of ambient light is at a value Lc0.

Furthermore, based on the light reception signal that is input from the light receiving module 7 via the ADC 8 when only the ambient light is received by the APD 7a, the lightness and darkness determination unit 1b determines whether the ambient state is light or dark. For details, for example, if the light reception signal is at or above a prescribed threshold, it is determined that the ambient state is light, and if the light reception signal is below the threshold, it is determined that the ambient state is dark. Moreover, the lightness and darkness determination unit 1b measures the maximum value of the light reception signal and estimates that the maximum level of the ambient light is at the maximum value.

As described above, in Step S2 in FIG. 6, in a case where the lightness and darkness determination unit 1b determines that the ambient state is light (light in Step S3), the amplification control unit 1c performs amplification ratio determination processing for the light state (Step S4). In the amplification ratio determination processing for the light state, based on the maximum level of ambient light that is estimated by the lightness and darkness determination unit 1b, the amplification control unit 1c determines an amplification ratio Mb for the light state for the APD 7a.

Specifically, first, for example, based on the maximum level of ambient light that is estimated by the lightness and darkness determination unit 1b, and on a table T4 for ambient light and noise, which is illustrated in FIG. 10, the amplification control unit 1c estimates a level of shot noise. The table T4 for ambient light and noise shows maximum levels Lx0, Lx1, . . . Lxn of the ambient light that is measured in advance by the measuring apparatus, and levels Ns0, Ns1, . . . Nsn of shot noise that results when the ambient light is received in the APD 7a, in such a manner that the maximum levels are associated with the levels of shot noise, respectively. Each of the maximum levels Lx0, Lx1, . . . Lxn of ambient light is equivalent to any one of the maximum levels La0 to La4 illustrated in FIG. 7, the maximum levels Lb0, Lb1, . . . Lbn illustrated in FIG. 8, and the maximum levels Lc0 and Lc1 illustrated in FIG. 9. The levels Ns0, Ns1, . . . Nsn of shot noise may be at measurement values that are measured by the measuring apparatus, and may be at calculation values that are calculated based on the maximum levels Lx0, Lx1, . . . Lxn of ambient light, and the like.

Because the maximum level Lx0 of ambient light, as described above, is at a value of 0 or at a value that is close to 0, the level Ns0 of shot noise that is associated with this is also at a value of 0 or at a value that is close to 0. When the ambient state is light, the lightness and darkness determination unit 1b does not estimate that the maximum level of ambient light is at the value Lx0. Pieces of information in the table T4 for ambient light and noise are stored in the storage unit 11. For example, if the maximum level of ambient light is at the value Lxn, the amplification control unit 1c estimates that the level of shot noise is at the value Nsn.

Furthermore, for example, in a case where light at the maximum level of ambient light that is estimated by the lightness and darkness determination unit 1b is received, the amplification control unit 1c estimates a maximum value (a current value or a voltage value) of the output signal of the APD 7a, and, based on the maximum value or a prescribed arithmetic-operation expression, estimates (calculates) a level of shot noise).

When the level of shot noise is estimated as described above, based on the level of the shot noise and a level (FIG. 5) of circuit noise that is stored in advance in the storage unit 11, the amplification control unit 1c determines the amplification ratio Mb for the light state. Specifically, the amplification control unit 1c, as illustrated in FIG. 5, determines an amplification ratio M2 as the amplification ratio Mb for the light state in such a manner that a difference between the level of shot noise and the level of circuit noise is a prescribed value X. Accordingly, the SN rate of the APD 7a is brought to the maximum. It is noted that the prescribed value X is set to a value that is equal to or greater than 0.

Next, the control unit 1 performs light emitting processing (Step S5). In the light emitting processing, the control unit 1 projects the laser light from the LD 2a, and scans the laser light over the prescribed range using the rotary scanning unit 4.

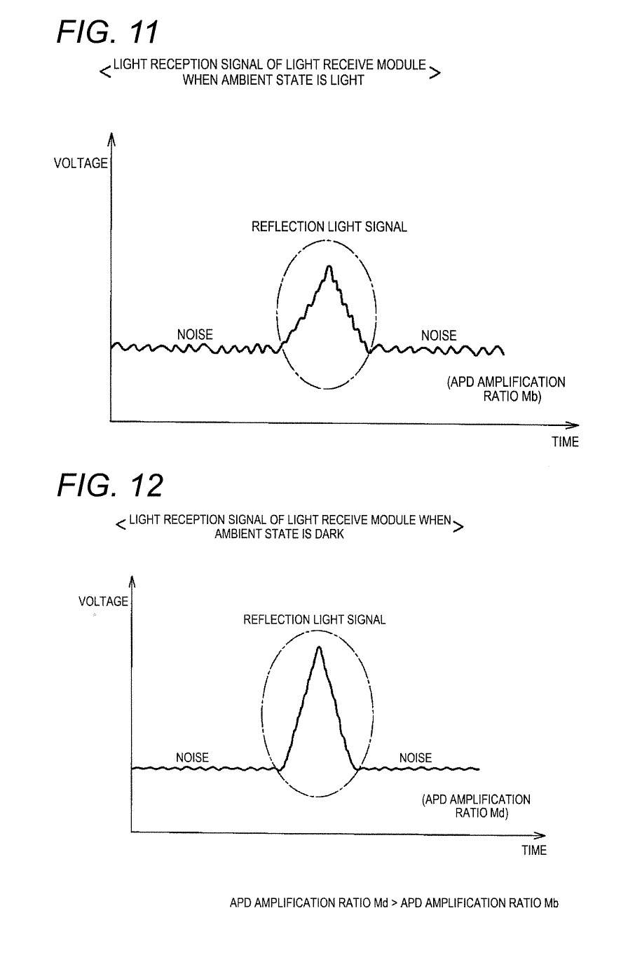

Furthermore, the control unit 1 performs light receiving processing for the light state (Step S6). In the light receiving processing for the light state, the amplification control unit 1c inputs the reference voltage in accordance with the amplification ratio Mb for the light state that is determined in Step S4, into the reverse voltage generation unit 9a using the reference voltage generation unit 9b of the signal amplification unit 9 and assigns the corresponding reverse voltage to the APD 7a using the reverse voltage generation unit 9a, and thus sets the amplification ratio for the APD 7a to be the amplification ratio Mb for the light state. Then, the reflection light that results from the laser light being reflected from the object 50 is received by the APD 7a, and the light reception signal that, according to the light-received state, is output from the light receiving module 7 is introduced into the object detection unit la via the ADC 8. At this time, because the ambient state is light, ambient light such as solar light is also received by the APD 7a. For this reason, the light reception signal that is output from the light receiving module 7 according to the light-received state of the APD 7a, for example, is as illustrated in FIG. 11.

FIG. 11 is a diagram illustrating the light reception signal that is output from the light receiving module 7 when the ambient state is light. The horizontal axis represents time, and the vertical axis represents a voltage (this is also true for FIG. 12 that is referred to for description). The reflection light reception signal from the object 50 is included in and noise is superimposed on the light reception signal that results when the ambient state is light. The nose is formed by the shot noise that occurs due to influence of ambient light such as solar light and the circuit noise. For this reason, as the amount of ambient light that is incident on the APD 7a increases, a level of noise is raised. However, as described above, when the ambient state is light, because the amplification ratio Mb for the light state, at which the SN ratio for the APD 7a is brought to the maximum, is set for the APD 7a, the SN ratio for the light reception signal from the light receiving module 7 is optimized. For this reason, for the light reception signal that results when the ambient state is light, it is easy to distinguish between the reflection light signal and the noise.

After Step S6 in FIG. 6, the object detection unit la performs object detection processing (Step S10). In the object detection processing, based on the light reception signal (FIG. 11) that is introduced by from the light receiving module 7 via ADC 8, the object detection unit la detects the reflection light signal and, based on the reflection light signal, determines whether the object 50 is present or absent or detects a distance to the object 50. After Step S10, returning to Step S3 takes place, and subsequent processing operations are repeatedly performed.

As another example, the object detection process in Step S10 is performed and then a sequence of operations may be ended. In this case, processing in each of Step Si to Step S10 may be repeatedly performed with a prescribed periodicity.

On the other hand, in Step S2, in a case where the lightness and darkness determination unit 1b determines that the ambient state is dark (dark in Step S3), the amplification control unit 1c performs the amplification ratio determination processing for the dark state (Step S7). In the amplification ratio determination processing in the dark, based on the maximum level of ambient light that is estimated by the lightness and darkness determination unit 1b, the amplification control unit 1c determines an amplification ratio Md for the dark state for the APD 7a.

In the amplification ratio determination processing for the dark state, based on the maximum level of ambient light that is estimated by the lightness and darkness determination unit 1b, the amplification control unit 1c estimates the level of shot noise in the same procedure as in the amplification ratio determination processing for the light state. Then, based on the level of shot noise and the circuit noise, the amplification ratio Md for the dark state is determined.

When the ambient state is dark, because an amount of ambient light is small, the level of shot noise that is measured by the amplification control unit 1c is lower than the level of shot noise that results when the ambient state is light. Particularly, because the solar light is not present in the nighttime or within a tunnel, the level of shot noise that is measured by the amplification control unit 1c is so extremely small that the level of shot noise is negligible. Then, regarding the noise that is included in the output of the APD 7a, the circuit noise is prevalent.

For this reason, if the estimated level of shot noise is an extremely low level that is below a prescribed threshold, the amplification control unit 1c disregards the shot noise. Then, for example, based on characteristics of the APD 7a in FIG. 5, which is stored in advance in the storage unit 11, amplification ratio M3 at which an SN ratio of the output signal to the circuit noise is set to be brought to the maximum is determined as the amplification ratio Md for the dark state. This is because the circuit noise is constant although the amplification ratio for the APD 7a changes and thus because the SN ratio is improved in proportion to a rise in the amplification ratio for the APD 7a when the shot noise is such at an extremely small that the shot noise can be disregarded, in a case where the ambient state is dark. It is noted that the amplification ratio M3 may be in advance calculated and may be stored in the storage unit 11. Furthermore, an upper limit amplification ratio for the APD 7a may be set in advance as the amplification ratio M3 for the dark state.

Furthermore, in some cases, although the ambient state is dark, the maximum level of ambient light that is estimated by the lightness and darkness determination unit 1b is raised due to an influence of the ambient light such as temporary illumination light and the level of shot noise that is estimated by the amplification control unit 1c increases as well.

As a result, in a case where the level of shot noise is at or above the prescribed threshold, the amplification control unit 1c determines the amplification ratio M2 (FIG. 5) at which a difference between the level of the shot noise and the level of circuit noise is set to be a prescribed value X, as the amplification ratio Md for the dark state. Although this is done, the SN ratio for the APD 7a is brought to the maximum.

As another example, the amplification control unit 1c may determine the amplification ratio M2 at which the difference between the level of the shot noise and the level of circuit noise is set to be the prescribed value X, as the amplification ratio Md for the dark state, without comparing the estimated level of shot noise and the prescribed threshold. Although this is done, as the estimated level of shot noise is lowered, the determined amplification ratio Md for the dark state increases. Because of this, the amplification ratio Md for the dark state is higher than the amplification ratio Mb for the light state. Furthermore, the SN ratio for the APD 7a is brought to the maximum.

Next, the control unit 1 performs light emitting processing (Step S8). Light emitting processing in Step S8 is the same as the light emitting processing in Step S5.

Furthermore, the control unit 1 performs the light receiving processing (Step S9). In the light receiving processing for the dark state, the amplification control unit 1c inputs the reference voltage in accordance with the amplification ratio Md for the dark state, which is determined in Step S7, into the reverse voltage generation unit 9a using the reference voltage generation unit 9b and assigns the corresponding voltage to the APD 7a using the reverse voltage generation unit 9a, and thus the amplification ratio for the APD 7a to be the amplification ratio Md for the dark state. Because the amplification ratio Md for the dark state is higher than the amplification ratio Mb for the light state, the reference voltage in accordance with the amplification ratio Md for the dark state and the reverse voltage are higher than the reference voltage in accordance with the amplification ratio Mb for the light state and the reverse voltage, respectively. When the amplification Md for the dark state, as described above, is set for the APD 7a, the reflection light that results from the laser light being reflected from the object 50 is received by the APD 7a, and the light reception signal that, according to the light-received state, is output from the light receiving module 7 is introduced into the object detection unit la via the ADC 8. At this time, because the ambient state is dark such as in the nighttime or within the tunnel, the ambient light such as the solar light is not received by the APD 7a. For this reason, the light reception signal that is output from the light receiving module 7 according to the light-received state of the APD 7a, for example, is as illustrated in FIG. 12.

FIG. 12 is a diagram illustrating the light reception signal that is output from the light receiving module 7 when the ambient state is dark. The reflection light reception signal from the object 50 is included in and noise is superimposed on the light reception signal that results when the ambient state is dark. When the ambient state is dark, because the ambient light such as the solar light is not almost present, in most cases, the noise is formed by the circuit noise. For this reason, as described above, although the amplification ratio Md for the dark state higher than the amplification ratio Mb for the light state is set for the APD 7a, in the light reception signal that results when the ambient state is dark, only the reflection light signal is amplified (FIG. 12). Furthermore, a level for the reflection light signal that results when the ambient state is dark is higher than a level for the reflection light signal (FIG. 11) that results when the ambient state is light. Furthermore, the level of noise (FIG. 12) that results when the ambient state is dark is easily set to be lower than the level of noise (FIG. 11) that results when the ambient state is light. Moreover, as described above, when the ambient state is dark, because the amplification ratio Md for the lark state, at which the SN ratio for the APD 7a is brought to the maximum, is set for the APD 7a, the SN ratio for the light reception signal from the light receiving module 7 is optimized. For this reason, for the light reception signal that results when the ambient state is dark, it is easy to distinguish between the reflection light signal and the noise.

After Step S9 in FIG. 6, based on the light reception signal (FIG. 12) that is introduced from the light receiving module 7 via the ADC 8, the object detection unit la performs the object detection processing (Step S10).

According to the embodiment described above, the light reception signal that is output from the light receiving module 7 is amplified by the signal amplification unit 9, not only when the ambient state is light, but also when the ambient state is dark. Because of this, the level for the reflection light signal that results from the object 50, which is included in the light reception signal, is raised. Furthermore, based on the reflection light signal, it can be easily determined whether the object 50 is present or absent or a distance to the object 50 can be easily measured. Furthermore, the amplification ratio for the light reception signal, which results when an amount of ambient light that is incident on the APD 7a is small and the ambient state is dark is set to be higher than the amplification ratio for the light reception signal, which results when the amount of ambient light that is incident on the APD 7a is large and the ambient state is light. For this reason, when the ambient state is dark, the level for the reflection light reception signal that is included in the light reception signal is set to be higher, and thus the reflection light signal and the noise can be easily distinguished and the precision of the detection of the object 50, which is based on the reflection light signal, can be improved. Furthermore, when the ambient state is light, the amplification ratio for the light reception signal is suppressed to be lower than when the ambient state is dark. Because of this, without excessively raising the level for noise that is included in the light reception signal, the noise and the reflection light signal can be easily distinguished and the precision of the detection of the object 50 that is based on the reflection light signal can be improved.

Furthermore, in the embodiment described above, the reverse voltage that is applied to the APD 7a is changed and the amplification ratio for the APD 7a is changed. Thus, the amplification ratio for the light reception signal that is output from the light receiving module 7 is changed. For this reason, with simple control in which, with the reverse voltage that is applied to the APD 7a when the ambient state is light, the reverse voltage that is applied to the APD 7a when the ambient state is dark is increased, the amplification ratio for the APD 7a, which is present when the ambient state is dark can be reliably caused to be higher than the amplification ratio for the APD 7a, which is present when the ambient state is light. Then, as a result, it is possible that the amplification ratio for the light reception signal, which is present when the ambient state is dark is reliably caused to be higher than the amplification ratio for the light reception signal, which is present when the ambient state is light.

Furthermore, in the embodiment described above, based on the calendar information or the positional information, which is acquired from the navigation device 31 via the ECU 30, the result of the detection by the solar radiation sensor 32, the state where the headlamp is turned on or off, or the determination data that is formed by the light reception signal from the light receiving module 7, the lightness and darkness determination unit 1b determines the ambient state of lightness or darkness. For this reason, in a case where the calendar information, the positional information, or the state where the headlamp is turned on or off is referred to, it can be correctly estimated whether the ambient state is light or dark. Furthermore, in a case where the result of the detection by the solar radiation sensor 32 or the light reception signal is referred to, based on the actually measured data on the ambient light at that time, it can be correctly estimated whether the ambient state is light or dark.

Furthermore, in the embodiment described above, based on the determination described above, the level for ambient light is estimated by the lightness and darkness determination unit 1b, and the amplification ratio for the APD 7a is set by the amplification control unit 1c and the signal amplification unit 9 according to the level for the ambient light. Thus, the light reception signal that is output from the light receiving module 7 is amplified. For this reason, according to the state of the ambient light that influences the ambient state of lightness or darkness, the amplification ratio for the APD 7a can be changed and the amplification ratio for the light reception signal can also be changed. Then, in the object detection unit 1a, it is possible that the precision of the detection of the reflection light signal that is included in the light reception signal is improved and that the precision of the detection of the object 50 is improved.

Moreover, in the embodiment described above, the maximum level for ambient light is estimated by the lightness and darkness determination unit 1b, and based on the maximum level, the level for the shot noise is estimated by the amplification control unit 1c. Then, based on the level for shot noise and the level for the circuit noise that is stored in advance, with the amplification control unit 1c and the signal amplification unit 9, the amplification ratio for the APD 7a is set and the light reception signal that is output from the light receiving module 7 is amplified. For this reason, considering the shot noise in accordance with the state of the ambient light, and the circuit noise, the amplification ratio for the APD 7a is changed and the amplification ratio for the light reception signal is changed as well. Thus, the SN ratio between the outputs of the APD 7a and the light receiving module 7 can be improved. Then, in the object detection unit 1a, it is possible that the precision of the detection of the reflection light signal that is included in the light reception signal from the light receiving module 7 is improved and that the precision of the detection of the object 50 is further improved.

According to the present invention, various embodiment other than the embodiment described above can be employed. For example, in the embodiment described above, the LD 2a is used as a light emitting element and the APD 7a is used as a light receiving element. However, the present invention is not limited only to these. A suitable number of light emitting elements other than the LD 2a may be provided on the light emitting module 2. Furthermore, a suitable number of light receiving elements other than the APD 7a may be provided in the light receiving module 7.

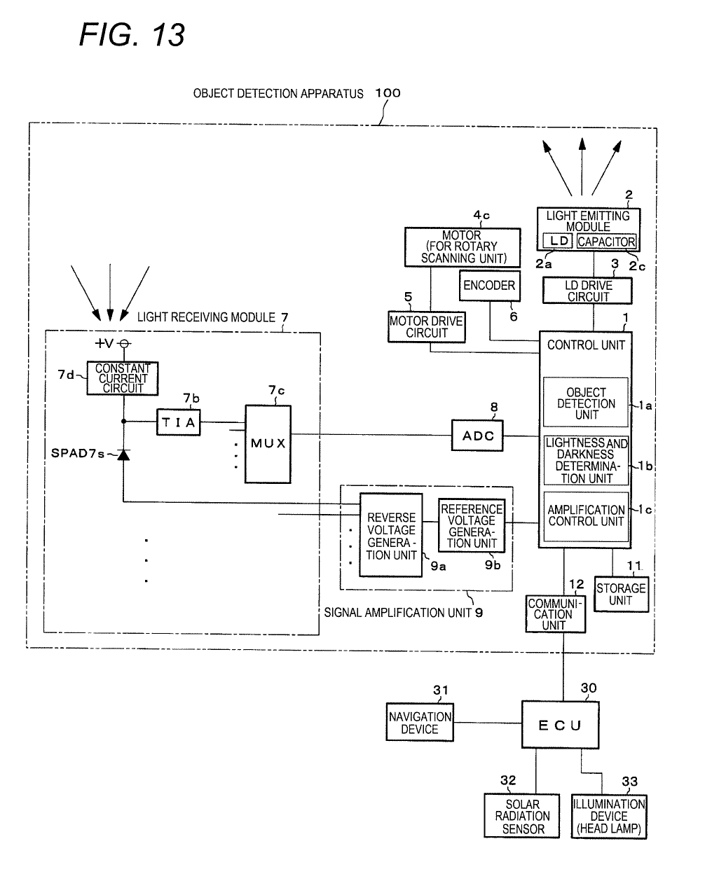

For example, as illustrated in FIG. 13, a single photon avalanche diode (SPAD) 7s may be provided as a light receiving module in the light receiving module 7. The SPAD 7s is a Geiger mode APD. One group is formed by one SPAD 7s, one TIA 7b, and one constant current circuit 7d. A plurality of SPADs 7s, a plurality of TIAs 7b and a plurality of constant current circuits 7d are provided in the light receiving module 7 (detailed illustrations of these are omitted).

Furthermore, one or more multi-pixel photon counters (MPPC) each of which including a plurality of pixels connected in parallel may be provided in the light receiving module, where one pixel is formed by connecting one end of a quenching resistor to an anode of the SPAD (illustrations of these are omitted).

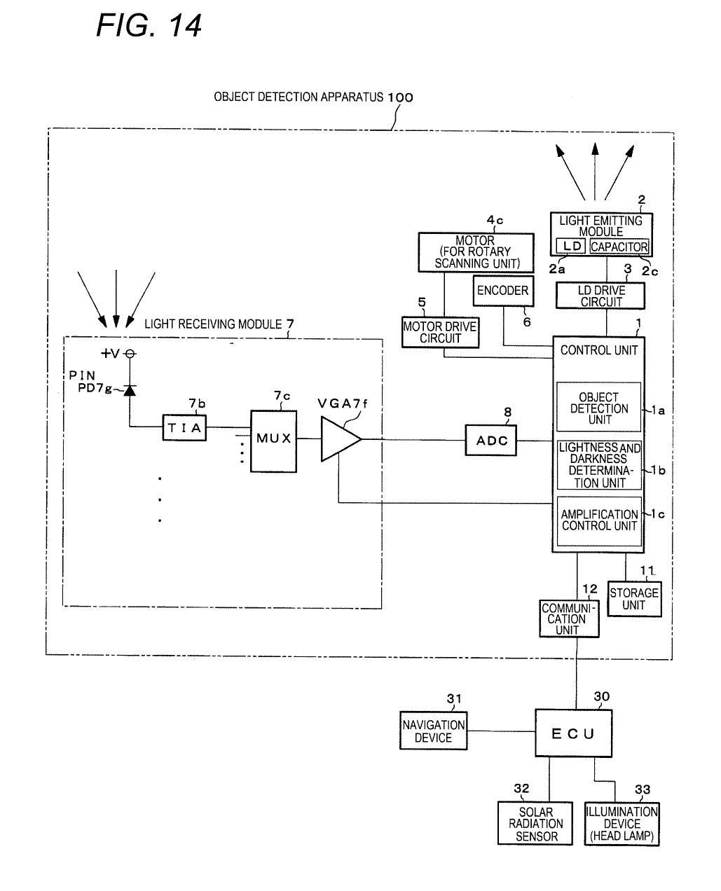

Furthermore, as illustrated in FIG. 14, a PIN type photodiode (PD) 7g may be provided as a light receiving element in the light receiving module 7. An anode of the PD 7g is connected to the TIA 7b, and a cathode of the PD 7g is connected to a power source +V. Furthermore, a plurality of PDs 7g and a plurality of TIAs 7b are provided in pairs in the light receiving module 7 (illustrations of these are omitted).

Furthermore, in the embodiment described above, an example is described in which the amplification ratio for the APD 7a that is a light receiving element is changed and thus the amplification ratio for the light reception signal that is output from the light receiving module 7 is changed, but the present invention is not limited only to this. In addition, for example, as illustrated in FIG. 14, a variable gain amplifier (VGA) 7f is connected to the output side of the MUX 7c and a gain that is present when an output signal of the MUX 7c is amplified by the VGA 7f is changed, and thus the amplification ratio for the light reception signal that is output from the light receiving module 7 may be changed. The VGA 7f is an example of a “signal amplification unit” according to one or more embodiments of the present invention. An amplification control unit 1d of the control unit 1 adjusts a gain of the VGA 7f, and thus, the amplification ratio that results when the ambient state is dark is caused to be higher than the amplification ratio that results when the ambient state is light. In FIG. 14, the PIN type PD 7g is used as a light receiving element, but other light receiving elements may be used.

Furthermore, in the embodiment described above, an example is described where the ambient state of lightness or darkness is determined based on the calendar information or the positional information, which is acquired from the navigation device 31 via the ECU 30, the result of the detection by the solar radiation sensor 32, the state where the headlamp is turned on or off, which is included in the illumination device 33, or the determination data that is formed by the light reception signal from the light receiving module 7, but the present invention is not limited only to this. In addition, for example, a calendar management unit that measures a date and time and stores sunrise time and sunset time is provided within the object detection apparatus 100 (the control unit 1 or the like), and necessary calendar information may be read. Furthermore, the solar radiation sensor 32 is connected directly to the object detection apparatus 100, and a result of the detection by the solar radiation sensor 32 may be acquired. Furthermore, the state where a lighting device other than the headlamp of the vehicle may be acquired directly or indirectly. Furthermore, based on other pieces of determination data, the ambient state of lightness or darkness may be determined. Furthermore, based on the determination data described above or one or more of the pieces of determination data, the ambient state of lightness or darkness may be determined.

Furthermore, in the embodiment described above, an example is described in which the maximum level of ambient light is estimated based on the determination data, the level of shot noise is estimated based on the maximum level, and the amplification ratio for the APD 7a is set based on the level of the shot noise and the level of circuit noise, and thus the light reception signal that is output from the light receiving module 7 is amplified, but the present invention is not limited only to this. A value (a level) may be used that is based on a result of arithmetic operation, such as an average of, a distribution of, or a standard deviation for measurement values of ambient light that are measured in advance. Furthermore, the estimation of the shot noise may be omitted, and the amplification ratio for the APD, which corresponds to each level of ambient light, may be set in advance and be stored in the storage unit 11. Furthermore, the estimation of the level of ambient light is omitted, the amplification ratios (the amplification ratio for the light reception signals) for the APDs, which are present when the ambient state is light and when the ambient state is dark, respectively, may be set and may be stored in the storage unit 11.

Furthermore, in the embodiment described above, an example is described in which, with the rotary scanning unit 4 that has a both-surface mirror 4a in the shape of a plate, the laser light or the reflection light is scanned over the prescribed range, but the present invention is not limited only to this. In addition, for example, a rotary scanning unit may be used that has a mirror of which three or more flank surfaces are reflective surfaces, such as a polygon mirror. Furthermore, for example, a minute rotary scanning unit may be used such as a laser scanning-type microelectromechanical systems (MEMS) that uses electromagnetic drive technique. Furthermore, the laser light from the LD is scanned over the prescribed range by the rotary scanning unit, but a configuration may be employed in which the reflection light that results from the object which is present in the prescribed range is received in the light receiving element without being caused to passing through the rotary scanning unit. Moreover, a configuration may be employed in which, without providing the rotary scanning unit, light is projected over the prescribed range from the light emitting element and this reflection light is received in the light receiving element.

Furthermore, in the embodiment described above, an example is described in which the voltage signal from the light receiving module 7 is output and is processed downstream, but the present invention is not limited only to this. In addition, for example, a current signal in accordance with output current from each light receiving element is output from the light receiving module 7 and is processed in the ADC 8 or the control unit 1 on the downstream side. Thus, it may be determined whether the object is present or absent or the distance to the object may be measured.

Moreover, in the embodiment described above, an example is given in which the present invention is applied to the object detection apparatus 100 that is formed by the laser radar for the vehicle, but the present invention may be applied to object detection apparatuses for other purposes.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. An object detection apparatus comprising:
a light emitting unit comprising a light emitting element that projects light over a prescribed range;
a light receiving unit comprising a light receiving element that receives reflection light resulting from an object existing in the prescribed range over which the light is projected from the light emitting unit;
an object detection unit that detects the object based on a light reception signal output from the light receiving unit according to a light-received state of the light receiving element;
a lightness and darkness determination unit that determines an ambient state of lightness or darkness;
a signal amplification unit that sets an amplification ratio for the light reception signal and causes the light reception signal to be output from the light receiving unit at a level in accordance with the amplification ratio; and
an amplification control unit that controls the amplification ratio for the light reception signal,
wherein the amplification control unit causes an amplification ratio for the light reception signal in a case where the lightness and darkness determination unit determines that the ambient state is dark to be higher than an amplification ratio for the light reception signal in a case where the lightness and darkness determination unit determines that the ambient state is light.

2. The object detection apparatus according to claim 1,
wherein the light receiving element comprises an avalanche photodiode,
wherein the signal amplification unit comprises a reverse voltage generation unit that generates a reverse voltage and applies the generated reverse voltage to the avalanche photodiode, and
wherein the amplification control unit causes the reverse voltage generation unit to change the amplification ratio for the light reception signal by changing the reverse voltage to be applied the avalanche photodiode.

3. The object detection apparatus according to claim 1,
wherein the lightness and darkness determination unit determines the ambient state of lightness or darkness based on calendar information, positional information, a result of detection by a solar radiation sensor, or a state where an illumination device that illustrates a vicinity thereof is turned on or off, which are acquired from an outside, or determination data comprising the light reception signal.

4. The object detection apparatus according to claim 3,
wherein the lightness and darkness determination unit estimates a level for ambient light based on the determination data, and
wherein the amplification control unit changes the amplification ratio for the light reception signal based on the level for the ambient light.

5. The object detection apparatus according to claim 4,
wherein the amplification control unit estimates a level of shot noise based on the level of the ambient light estimated by the lightness and darkness determination unit, and changes the amplification ratio for the light reception signal based on the level of shot noise and a level of circuit noise that is stored in advance.
